(19) United States
(12) Patent Application Publication
(10) Pub. No.: US 2026/0037727 A1
(43) Pub. Date: Feb. 5, 2026

(54) SYSTEM AND METHOD OF IDENTIFYING AND RESPONDING TO TOXIC LANGUAGE WITHIN USER QUERY INPUTS RECEIVED AT AN ON THE BOX ARTIFICIAL INTELLIGENCE PRODUCTIVITY TOOL

(71) Applicant: Dell Products LP, Round Rock, TX (US)

(72) Inventors: Ashutosh Singh, Austin, TX (US); Mona Sachdev, Round Rock, TX (US); Srikanth Kondapi, Austin, TX (US)

(73) Assignee: Dell Products LP, Round Rock, TX (US)

(21) Appl. No.: 18/788,836

(22) Filed: Jul. 30, 2024

(51) Int. Cl. G06F 40/279; G06F 16/33

(52) U.S. Cl. CPC G06F 40/279; G06F 16/3344

(57) ABSTRACT

An information handling system executing computer readable code instructions for an on the box artificial intelligence (AI) productivity tool may comprise a hardware processor executing computer-readable code instructions for generating toxicity intent values from natural language descriptions of defined toxic utterances that include metadata identifying a toxicity type and a defined response to the toxic utterance, generating a query input intent value for a user query input received via a user requesting an action by an AI productivity tool-enableable software, performing a cosine semantic similarity search comparing the toxicity intent values to the query input intent value to identify a matching toxic utterance in the user query input having a toxicity intent value that generates a highest toxicity cosine semantic similarity search score, and instructing the user interface to provide the defined response from metadata for the identified toxic utterance of a heightened type.

### FIELD OF THE DISCLOSURE

The present disclosure generally relates to execution of computer readable code instructions of on-the-box (OTB) artificial intelligence (AI) productivity tools with an information handling system. The present disclosure more specifically relates systems and methods of identifying and responding to toxic language within a received user query input at an OTB AI productivity tool.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more software applications such as workspace productivity applications, or gaming applications or the like. Further, the information handling system may include AI productivity tools that interface with various AI productivity tool-enablable software applications such as natural language chat-enabled environments for interface with services of software applications that increase the efficiency of the operation of the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes an on the box (OTB) artificial intelligence (AI) productivity tool to select among a plurality of AI productivity tool-enablable software application capabilities for services, operations, or responses to a user query input according to an embodiment of the present disclosure;

FIG. 2 is a block diagram illustrating computer readable code instructions for an OTB AI productivity tool executable on an information handling system for matching a determined query intent value for a user's query input to a toxicity intent value for a natural language description of a defined toxic utterance and for determining a responsive matching capability, if allowed, according to an embodiment of the present disclosure;

FIG. 3 is a block diagram illustrating a method of executing computer readable code instructions of modules of an OTB AI productivity tool to identify a toxic intent value generated from a natural language description of a toxic utterance that best matches a received user query input by having a toxicity intent value that generates a highest toxicity cosine similarity search score with a query intent value according to an embodiment of the present disclosure;

FIG. 4 is a block diagram illustrating a method of executing computer readable code instructions of modules of an OTB AI productivity tool to identify a defined toxic utterance that best matches a received user query input by weighting a semantic similarity search score by a text frequency-inverse document frequency (TF-IDF) similarity search score for a received user query input compared to the defined toxic utterance according to an embodiment of the present disclosure; and

FIG. 5 is a flowchart showing a method of executing computer readable code instructions of modules of an OTB AI productivity tool to identify and respond to a defined toxic utterance that best matches a received user query input through a TF-IDF weighted semantic search that considers context of terms as well as keywords within the user query input or for determining a matching capability, if allowed, according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase efficiency of computing systems and interactions with humans. An example of AI technologies includes, but is not limited to, chat-enabled environments (voice, text, etc.). These chat-enabled environments are described in embodiments herein as an on-the-box (OTB) AI productivity tool that receives this voice or text input from a user and implements a number of actions or utilizes services of various software applications based on the natural language of the input. In some information handling systems, the OTB AI productivity tool may interface with various AI productivity tool-enablable software applications being executed or executable on the information handling system. These AI productivity tool-enablable software applications may integrate with the OTB AI productivity tool to allow user queries to trigger certain actions declared, supported, and managed by these AI productivity tool-enablable software applications.

In some cases, user query inputs received within these chat-enabled environments, such as via a user conversational interface software application may include inappropriate or toxic language, such as profane, vulgar, racist, sexist, or otherwise offensive remarks. Such toxic language may appear within user query inputs in various scenarios. For example, the user providing that user query input may not have been talking to the user conversational interface software application when the utterance was made. In another example, the toxic language may appear within an otherwise appropriate request, which may occur when the user becomes agitated or frustrated. In still other cases, the toxic language may have been used purposefully and directed specifically at the user conversational interface software application. Each of these scenarios, and other scenarios in which such toxic language may be identified within a user query input may be associated with a different response determined by operators of the OTB AI productivity tool as appropriate for the situation. Having an OTB AI productivity tool respond to toxic language may be undesirable to an information technology decision maker (ITDM), enterprise, or the user in many cases. The OTB AI productivity tool in embodiments of the present disclosure may identify any of a defined list of toxic utterances and phrases within received user query inputs, classify severity of those toxic utterances based in part on contextual understanding of the toxic utterance within the user query input, and provide an appropriate response defined for the identified toxic utterance to the user, if one is found, before providing a responsive action to the user query input in embodiments herein.

A hardware processor executing code instructions of the OTB AI productivity tool in embodiments herein may match the received user queries, or user query inputs to one or more natural language descriptions of pre-defined toxic utterances through execution by a hardware processor of machine readable code instructions for one or more natural language processing machine learning models. These predefined toxic utterances and any associated responses or classifications of toxicity type may be received as defined toxic utterance policy updates from an ITDM setting these at a remote management server and defined toxic utterances may be modified as needed in embodiments herein. These natural language descriptions of the defined toxic utterances may be stored within a toxic utterance database for comparison to received user query inputs. Each such toxic utterance may include metadata identifying a type describing the severity of the toxic utterance, such as heightened or general, as well as a defined response for each type, and whether a responsive action from capabilities of an AI productivity tool enableable software application will be allowed. For example, toxic utterances having a heightened type may include specific phrases, or offensive remarks regarding religion, gender, sexual-orientation, or race, while single curse words or less profane language may be given a general type. Further, each type may be assigned a different response in the user query input with a responsive action. For example, a heightened type of toxic utterance may be associated with a defined response to inform the user that she has included unacceptable or offensive language, or to admonish the user for use of such toxic language, and may further include notification of refusal to accommodate the request. As another example, a general type of toxic utterance, such as a single curse word used within an otherwise acceptable request for an AI productivity tool enableable software application executing on the information handling system to perform capability for a responsive action may also be associated with a defined response, or no response, that still includes performance of the requested action.

In order to identify toxic utterances within received user query inputs, a hardware processor executing machine readable code instructions for a toxicity intent value generator of the OTB AI productivity tool may determine toxicity intent values associated with these natural language descriptions of the defined toxic utterances. These toxicity intent values may be represented by a mathematical value in a multi-axis vector space that may be associated with a natural language description for that toxic utterance, which may be a single word or a phrase. Generating such toxicity intent values as vectors may be a first step in a natural language processing method to determine and correlate the user's query intent or requested action within a user query input that takes into account the context or semantics of the words used within the user query input with identifying one of a plurality of toxic utterances or finding no identified toxic utterances.

Upon receipt of a user query input by the OTB AI productivity tool in embodiments herein, a hardware processor executing code instructions of a query intent determination module may determine a vectorized query input intent value for the user query input that may be comparable to the toxicity intent values and later, if allowed, comparable to capability intent values for responsive capabilities. The hardware processor executing machine readable code instructions for a query intent to toxicity determination module in embodiments herein may then perform one or more similarity search methods to match the query input intent value with a toxicity intent value in order to identify a toxic utterance given within the user query input. A methodology for matching text of user query inputs in embodiments herein may center, in part, upon keyword searches, such as term frequency-inverse document frequency (TF-IDF) searches. TF-IDF searches in this context focus upon the frequency of a term or keyword, such as a curse word or offensive word, found within a user query input and within registered toxic utterances. TF-IDF methodologies lack the ability to determine context of the various keywords identified within the user query input, however. For example, TF-IDF methodologies cannot discern between a non-offensive word used in a non-offensive way and the same word used in a highly offensive manner in a different context. This may result in limits for matching between natural language text excerpts, such as the user query input and the natural language description of various toxic utterances.

In embodiments herein, a hardware processor may execute machine readable code instructions for a semantic similarity search machine learning model that analyzes and weighs context and relevancy to overcome this disadvantage of lexical TF-IDF methodologies alone. For example, in embodiments herein, a hardware processor may execute machine readable code instructions for a semantic similarity search machine learning model, via a query intent to toxicity module, that compares the vectorized user query input intent value and the toxicity intent values stored within the toxic utterances database. Such a comparison may be performed using a semantic search machine learning model, such as a cosine similarity search that compares the distance or value difference in a multi-axis vector space to determine correlations between two vectors (e.g., the toxicity intent value vector and the user query input value vector) to determine the contextual similarity between the natural language description of the defined toxic utterance and the natural language user query input. Such a contextual or semantic search methodology may take into account the fact that the same word may be used in a non-offensive way or in a highly offensive manner, for example. This may be performed for several of the toxicity intent values stored within the toxic utterances database to identify a toxicity intent value that most closely matches the user query input value. In such a way, a hardware processor executing code instructions for the query intent to toxicity module for the OTB AI productivity tool may take relevance and context of natural language within a user query input into account when determining a matching toxic utterance within the user query input.

While semantic search methodologies are better-suited for use with context of natural language text excerpts than TF-IDF methodologies that do not consider context, TF-IDF methodologies are better-suited than semantic search methodologies where a single keyword within the user query input is most important to identifying a matching capability for an AI productivity tool-enableable software application to address the user's concerns. For example, a user may provide a natural language user query input that includes one or more single-word expletives. In such a case, it may be useful to also perform a TF-IDF comparison across the stored natural language descriptions of the toxic utterances within the toxic utterances database to most quickly and confidently identify use of those specific expletives within the user query input according to embodiments herein.

As described in embodiments herein, a hardware processor executing machine readable code instructions for the query intent to toxicity determination module of the OTB AI productivity tool may compare the vectorized user query input intent value and each of several toxicity intent values using a semantic search approach, such as a cosine similarity search or comparison. Thus, the hardware processor executing machine readable code instructions for the query intent to toxicity determination module may compare a single user query input to a plurality of natural language descriptions of defined toxic utterances. In order to increase the accuracy of these semantic comparison results, the hardware processor executing machine readable code instructions for the query intent to toxicity determination module of the OTB AI productivity tool in embodiments herein may, for each compared user query input and natural language description of a toxic utterance, perform a TF-IDF comparison. The output of the semantic search comparison may then be weighted by the TF-IDF comparison for cach natural language description of a defined toxic utterance compared to the user query input, via the hardware processor executing machine readable code instructions of the query intent to toxicity determination module. The natural language description of a toxic utterance having the highest weighted score may then be identified, via execution of machine readable code instructions of the query intent to toxicity determination module by the hardware processor as having been used within the user query input. In other cases, execution of machine readable code instructions of the query intent to toxicity intent determination module may find no identified toxic utterances within the user query input.

The hardware processor executing code instructions for the query intent to toxicity module for the OTB AI productivity tool may then identify the type of the toxic utterance defined within metadata for the identified toxic utterance used within the user query input and provide the defined response also found within metadata. For example, the hardware processor executing code instructions for the query intent to toxicity intent module for the OTB AI productivity tool may instruct the user conversational interface software application to provide a response to the user, such as informing the user of or admonishing the user for use of such a toxic utterance, or refusal to perform the requested action within the user query input. As another example, the hardware processor executing code instructions for the query intent to toxicity intent module for the OTB AI productivity tool may identify that the toxic utterance is of a general type, such as a single curse word used within an otherwise acceptable request or in which no toxic utterance is identified within the user query input request, for an AI productivity tool enableable software application executing on the information handling system execute a capability to perform an action responsive to a user query input. In such a case, the OTB AI productivity tool may still identify a best match responsive capability. For example, the hardware processor may execute machine readable code instructions of an OTB AI productivity tool query intent to capability determination module to identify the AI productivity tool enableable software application natural language capability having a highest TF-IDF weighted cosine or other semantic similarity search score above a minimum threshold as the best match capability for the received user query input. In such scenarios, the hardware processor executing code instructions for the query intent to toxicity module for the OTB AI productivity tool may further instruct the AI productivity tool enableable software application to perform the identified action for the best match capability for the received user query input. In such a way, the hardware processor executing code instructions for the OTB AI productivity tool may identify and provide a defined appropriate response to the use of toxic utterances within received user query inputs.

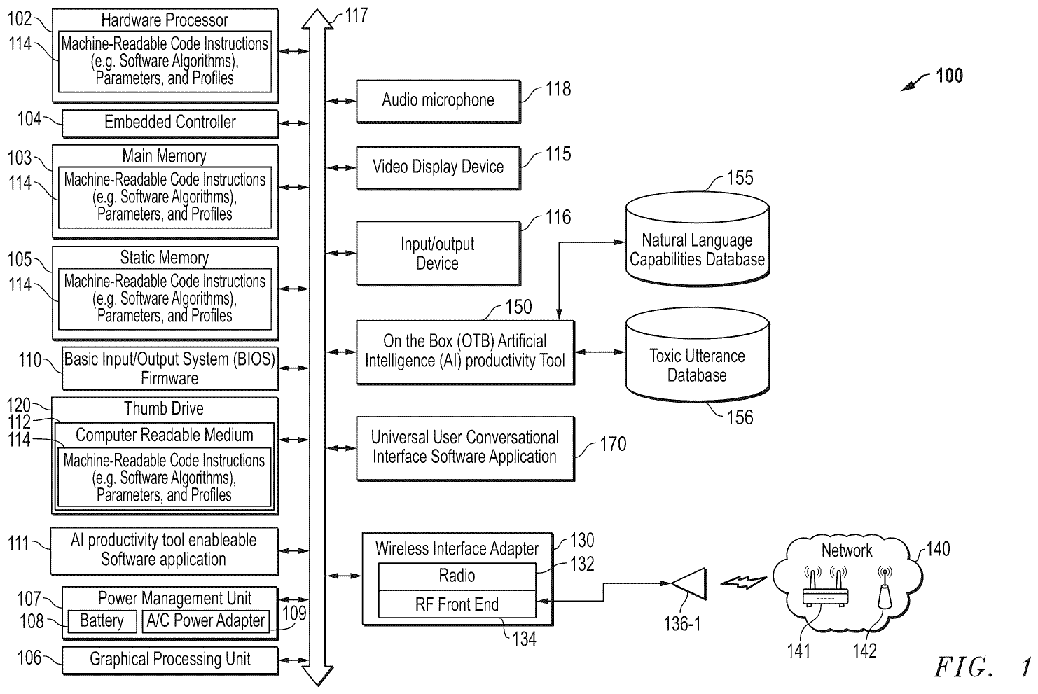

Turning now to the figures, FIG. 1 illustrates an information handling system 100 similar to the information handling systems according to several aspects of the present disclosure. As described herein, hardware processor 102 executing machine-readable code instructions of an on the box (OTB) artificial intelligence (AI) productivity tool 150 in an embodiment may perform one or more similarity search methods to match a received user query input and query input intent value with a toxicity intent value for a natural language description for a defined toxic utterance. The OTB AI productivity tool 150 in an embodiment may receive, via a universal user conversational interface software application 170 or other audio or text interface, a voice or text input from a user, described herein as a user query input, that includes a toxic utterance. The hardware processor may execute machine readable code instructions of the OTB AI productivity tool 150 to identify a natural language capability of the AI productivity tool enableable software application 111 having a highest TF-IDF weighted cosine or other semantic similarity search score above a minimum threshold as a best match capability responsive to the received user query input, if allowed in embodiments herein. The hardware processor 102 may execute machine readable code instructions for a semantic similarity search machine learning model that analyzes and weighs context and relevancy of the natural language within the user query input to identify a defined toxic utterance, if one is there, from natural language descriptions of the user query input.

In an embodiment, the hardware processor 102 executing machine readable code instructions for the OTB AI productivity tool 150 may similarity match or correlate received user queries, or user query inputs to defined toxic utterances by comparing natural language descriptions of the toxic utterances to the natural language text of the user query input. The hardware processor 102 executing machine readable code instructions of the OTB AI productivity tool 150 may determine toxicity intent values associated with natural language descriptions of the defined toxic utterances, each stored in the toxic utterance database 156. The defined toxic utterances may be received from an information technology decision maker (ITDM) or user via one or more defined toxic utterance policy updates that may change or alter the defined toxic utterances, responses, classification and other policy parameters in various embodiments. Each stored and defined toxic utterance within the toxic utterance database 156 in an embodiment may include metadata identifying a type describing the severity of the toxic utterance, such as heightened or general, as well as a defined response for each type. For example, toxic utterances having a heightened type may include specific phrases, or offensive remarks regarding religion, gender, sexual-orientation, or race, while single curse words or less profane language may be given a general type. Further, cach type may be assigned a different response. For example, a heightened type of toxic utterance may be associated with a defined response to inform the user that she has included unacceptable or offensive language, or to admonish the user for use of such toxic language, and may further include notification of refusal to accommodate the request, in some cases. As another example, when no toxic utterance is identified or the identified toxic utterance is of a general type, such as a single curse word used within an otherwise acceptable request, an AI productivity tool enableable software application 111 executing on the information handling system 100 may still execute a best match capability to perform an action, along with any defined response, in response to a user query input.

The toxicity intent values generated for the defined toxic utterances stored within the toxic utterances database 156 may be represented by a mathematical value that is an embedded toxicity intent value in a multi-axis vector space that may be associated with a natural language description for that toxic utterance. The hardware processor 102 may execute machine readable code instructions of the OTB AI productivity tool 150 to perform a cosine similarity search or comparison that compares a vectorized user query input intent value and vectorized toxicity intent values to determine the contextual similarity between the natural language description of the defined toxic utterance and the natural language user query input. This may be performed for several of the toxicity intent values to identify a toxicity intent value that most closely matches or correlates with the user query input value. In such a way, the hardware processor 102 executing code instructions for the OTB AI productivity tool 150 may take relevance and context of natural language within a user query input into account when determining a matching or correlating toxic utterance given within the user query input.

In another embodiment, in order to increase the accuracy of the above-described semantic search or comparison results, such as the cosine semantic similarity algorithm, the hardware processor 102 executing machine readable code instructions for the OTB AI productivity tool 150 in an embodiment may, for each compared user query input and natural language description of a defined toxic utterance, also perform a TF-IDF comparison. The output of the semantic search comparison may then be weighted by the TF-IDF comparison for each natural language description of a defined toxic utterance compared to the user query input, via the hardware processor 102 executing machine readable code instructions of OTB AI productivity tool 150. The natural language description of the defined toxic utterance having the highest weighted score that exceeds a minimum match threshold may then be identified, via execution of machine readable code instructions of the OTB AI productivity tool 150 by the hardware processor 102 as having been used within the user query input received via the universal user conversational interface software application 170 or other user input interface. In such a way, the hardware processor 102 executing code instructions for the OTB AI productivity tool 150 may enhance semantic search performance by also considering critical keywords when determining a matching toxic utterance.

The hardware processor 102 may execute machine readable code instructions of the OTB AI productivity tool 150 to identify the AI productivity tool enableable software application 111 natural language capability, stored within a natural language capabilities database 155 having a highest TF-IDF weighted cosine or other semantic similarity search score above a minimum threshold as the best match capability for the received user query input. As described herein, a general type of toxic utterance, such as a single curse word used within an otherwise acceptable request for an AI productivity tool enableable software application 111 executing on the information handling system 100 to perform an action of which it is capable may be associated with a defined response that includes still permitting performance of the requested action. In such a case, or when no toxic utterance is identified within the user query input, a hardware processor 102 executing code instructions of the OTB AI productivity tool 150 in an embodiment may match the received user queries, or user query inputs to known capabilities of one or more of the AI productivity tool-enableable software applications 111 through execution by the hardware processor 102 of machine readable code instructions for one or more natural language processing machine learning models. AI productivity tool enableable software application 111 may have or publish a list of recognized “capabilities” or functionalities that it may perform during execution of such an AI productivity tool enableable software application 111 in response to a query input received and processed by the OTB AI productivity tool 150 into a query intent vector value. These capabilities stored at the natural language capabilities database 155 may include any input and output capabilities provided by the AI productivity tool-enablable software applications 111 being executed by the hardware processor 102, 104, or 106.

Upon registration of a given capability by the AI productivity tool enableable software application 111 in an embodiment, a hardware processor 102 for the information handling system 100 may execute machine readable code instructions for one or more text embedding algorithms to generate a multi-dimensional vector capability intent value for that capability that, for example, may be based on text descriptors for that capability. The capabilities are provided text descriptors that may be processed into vectorized capability intent values in a multi-axis vector space such that these intent value mathematical representations of a query and a capability may be correlated by a similarity matching algorithm to select a capability responsive to an input query from a user.

When the user provides the user query input, which may or may not also contain toxic utterances as described above, the hardware processor 102 executing machine-readable code instructions of the OTB AI productivity tool 150 in an embodiment may orchestrate assessment of the user's intended goals within the user query input (e.g., what the user wishes to achieve with this communication) with determination of a query input intent value, and identify one or more capabilities associated with the AI productivity tool enableable software application 111 having a correlating capability intent value and that is capable of executing a response to this user query input intent. A user query input may correlate to a registered capability for the AI productivity tool enableable software application 111 in an embodiment if the capability cosine semantic similarity search or TF-IDF weighted capability cosine semantic similarity search provides a score for that capability that exceeds a minimum match threshold, such as, for example, 0.1, 0.15, 0.2, or 0.5. If the hardware processor 102 executing machine readable code instructions of the OTB AI productivity tool 150 determines that the best match capability is associated with the AI productivity tool enableable software application 111, the hardware processor 102 may execute machine readable code instructions of the OTB AI productivity tool 150 to instruct the AI productivity tool enableable software application 111 to execute the best match capability.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 116, a video/graphics display device 115, an audio microphone 118 for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more software or firmware systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100. In a specific embodiment, code instructions for the OTB AI productivity tool 150, the universal user conversational interface software application 170, and one or more AI productivity tool enableable software applications 111 may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 116 as well as between hardware processors 102, an EC 104, GPU 106 or other, the operating system (OS) 111, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 116 described herein. As described herein, the information handling system 100 further includes a video/graphics display device 115. The video/graphics display device 115 in an embodiment may function as a liquid crystal display (LCD), an organic light emitting diode (OLED), a flat panel display, or a solid-state display. It is appreciated that the video/graphics display device 115 may be wired or wireless and may be an external video/graphics display device 115 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHZ, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, hardware processor or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing.

Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 111, and/or via an application programming interface (API) include a unified device API described herein. An example OS 111 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 115, or other wired I/O devices 116 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

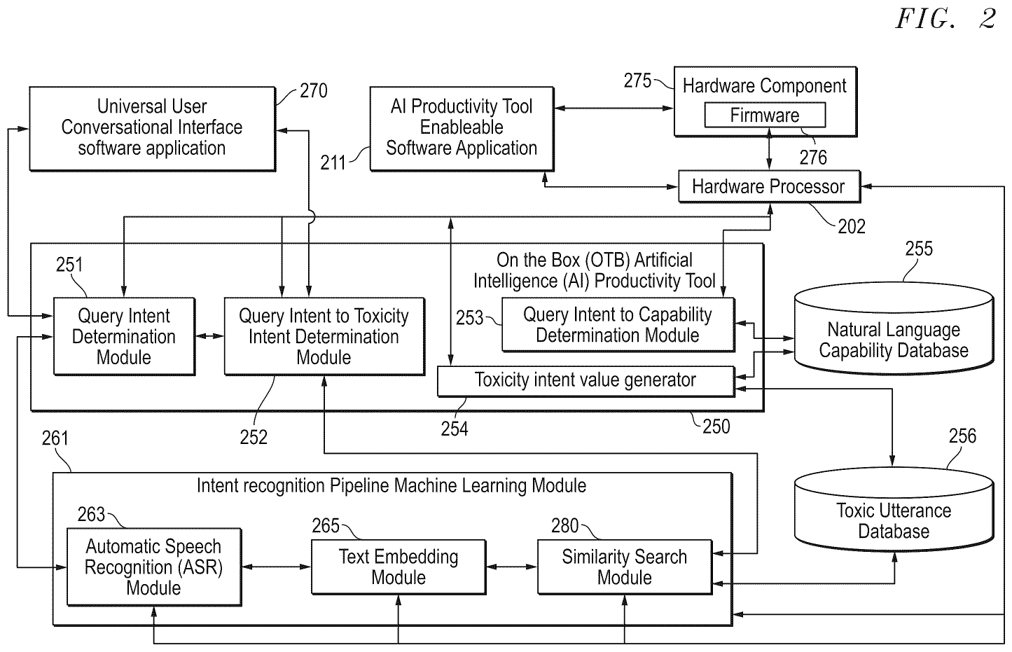

FIG. 2 is a block diagram illustrating an OTB AI productivity tool for correlating a determined query intent value for a user's query input to a toxicity intent value for a natural language description of a defined toxic utterance and to a capability intent value for a responsive capability, if allowed, according to an embodiment of the present disclosure. The OTB AI productivity tool 250 and a AI productivity tool enableable software application 211 in an embodiment may then execute a defined appropriate response for the toxic utterance identified within the chatbot input query and may execute a responsive capability as an action for a user query input, if permitted. A manufacturer of edge devices, such as personal or enterprise computers, may develop and install on individual edge device information handling systems machine readable code instructions for an OTB AI productivity tool 250 that employs one or more locally executed machine learning models, such as 263, 265, or 280, to optimize user productivity and performance with the information handling system using artificial intelligence methodologies. Examples of artificial intelligence methodologies includes ML model algorithms used with chatbots, such as universal user conversational interface software application 270 to simulate conversations between the information handling system executing machine readable code instructions of the AI productivity tool enableable software application 211 and the user, via the OTB AI productivity tool 250 to execute one or more capabilities for firmware or hardware operations, an application software service, response or other function in response to a user query input. For example, a response to a user query via OTB AI productivity tool 250 may trigger processes of one or more AI productivity tool enableable software applications 211 for capabilities to execute a responsive action in embodiments herein.

The OTB AI productivity tool 250 in an embodiment may receive, via a universal user conversational interface software application 270 or other interface, a voice or text input from a user, described herein as a user query input, that requests actions, services, or other responses of various software applications in natural language. In some cases, such received user query inputs may include toxic utterances, either in combination with a valid request for an action by an AI productivity tool enableable software application 211, or separate and apart from such a valid request. For example, the user providing that user query input may not have been talking to the user conversational interface software application 270 when the utterance was made. In another example, the toxic language may appear within an otherwise appropriate request, which may occur when the user becomes agitated or frustrated. In still other cases, the toxic language may have been used purposefully and directed specifically at the user conversational interface software application 270. In still other cases, the user query input may contain no identified toxic utterances at all. Each of these scenarios may be associated with a different response determined by a received defined toxic utterance policy update for the OTB AI productivity tool 250 as appropriate for the situation. Such a defined toxic utterance policy update may be received from an information technology decision maker (ITDM) or user in embodiments herein and may be adjusted or updated as needed. The hardware processor 202 executing machine readable code instructions for the OTB AI productivity tool 250 in an embodiment may identify any of a defined list of toxic utterances and phrases within received user query inputs, classify severity of those toxic utterances based in part on contextual understanding of the toxic utterance within the user query input, and provide an appropriate response defined for the identified toxic utterance to the user in accordance with a received defined toxic utterance policy update.

A hardware processor 202 executing code instructions of the OTB AI productivity tool 250 in an embodiment may match these user query inputs to natural language descriptions of defined toxic utterances stored within the toxic utterance database 256 through execution by the hardware processor 202 of machine readable code instructions for one or more natural language processing machine learning models. The natural language descriptions of defined toxic utterances are generated by an ITDM or user in a received defined toxic utterance policy update for the OTB AI productivity tool 250 and provided with text descriptors that may be processed into vectorized toxicity intent values in a multi-axis vector space. These vectorized intent values are mathematical representations of a query or a toxic utterance that may be correlated by a similarity matching algorithm to identify the use of such a toxic utterance within a user query input. Each such natural language of a toxic utterance stored in the toxic utterance database 256 may include metadata identifying a type describing the severity of the toxic utterance, such as heightened or general, as well as a defined response for each type. For example, toxic utterances having a heightened type may include specific phrases, or offensive remarks regarding religion, gender, sexual-orientation, or race, while single curse words or less profane language may be given a general type. Further, each type may be assigned a different response. For example, a heightened type of toxic utterance may be associated with a defined response to inform the user that she has included unacceptable or offensive language, or to admonish the user for use of such toxic language, and may further include notification of refusal to accommodate the request, via the user query input. As another example, when no toxic utterance is identified or a general type of toxic utterance, such as a single curse word is used within an otherwise acceptable request for an AI productivity tool enableable software application executing on the information handling system execute a best matched capability to perform an action, such a user query input may be associated with a defined response that still includes performance of the requested action.

The hardware processor 202 executing machine readable code instructions for a toxicity intent value generator 254 of the OTB AI productivity tool 250 may determine toxic intent values associated with natural language descriptions of the defined toxic utterances stored in the toxic utterance database 256. These toxicity intent values are a mathematical representation of the natural language descriptions of the defined toxic utterances in an embodiment. These toxicity intent values may be represented by a mathematical value in a multi-axis vector space that may be associated with the natural language description for that defined toxic utterance and stored within the toxic utterance database 256. Generating such toxicity intent values as vectors may be a first step in a natural language processing method to determine when a toxic utterance has been used within a user query input that takes into account the context or semantics of the words used within the user query input.

Upon determination of a toxicity intent value for each of the natural language descriptions of the defined toxic utterances stored in the toxic utterance database 256, the OTB AI productivity tool 250 may begin processing received user query inputs from the universal conversational interface software application 270. In an example embodiment, a user may provide a user query input in the form of text or voice data (e.g., via IO device 116, or microphone 118 of FIG. 1) to a universal user conversational interface software application 270. The hardware processor executes machine readable code instructions of the OTB AI productivity tool 250 as a chatbot to simulate a conversation between the user and the one or more AI productivity tool enableable software applications 211, via the user conversational interface software application 270. When a user provides a user query input in the form of text or voice data (e.g., via IO device 116, or microphone 118 of FIG. 1) to the universal user conversational interface software application 270, the hardware processor 202 executing machine-readable code instructions of the OTB AI productivity tool 250 in an embodiment may orchestrate assessment of the user's requests for a responsive action within the user query input (e.g., what the user wishes to achieve with this communication) with determination of a query input intent value, and identify one or more capabilities associated with the AI productivity tool enableable software application 211 having a correlating capability intent value and that is capable of executing a response to this user query input intent. However, as described herein, in some cases these received user query inputs may include some form of toxic language defined within the toxic utterance database 256.

In order to detect the use of such toxic language, or toxic utterances, the hardware processor 202 executing machine-readable code instructions of the query intent determination module 251 may receive the user query input via microphone, image, or text input, and initiate execution of machine readable code instructions for an intent recognition pipeline machine learning module 261. In an embodiment, the hardware processor 202 executing machine-readable code instructions for the intent recognition pipeline machine learning module 261 may further orchestrate any combination of a plurality of machine learning modules (e.g., 263, 265, or 280) to process the audio or text input to determine the user's intended goal or query intent and any toxic language used within the received text or voice data of the user query input. During operation for example, the hardware processor 202 executing machine-readable code instructions of the query intent determination module 251 may load one or more machine learning models such that, for example, the text or voice input from the user may be processed through a speech recognition model 263 and/or processed through any of a plurality of natural language models (e.g., 265 or 280) or other ML models in order to determine a text of a user's input query or determine a vector intent value of the user's input query. For example, an automatic speech recognition (ASR) module 263, a text embedding module 265, or a similarity search module 280 may work in various combinations with one another to detect a user's audio speech input, convert to text or detect text, and generate a query intent to detect the use of toxic language. The generating of a query intent vector value from the text of the user query input received from the user conversational interface software application 270 or other interface, such as one specific to an AI productivity tool enableable software application 211, may be used to semantically or lexically match to a defined toxic utterance that may be in the user query input. Further, the hardware processor 202 executing machine-readable code instructions of an intent recognition pipeline machine learning module 261 may orchestrate the interplay between each of the ASR module 263, text embedding module 265, and similarity search module 280 to establish a query intent vector value or a toxicity intent vector value in a multi-axis vector space defined with these machine learning models and correlate that query intent value with a corresponding toxicity intent value in an embodiment. Several text embedding algorithms may be used in various embodiments herein in order to provide a vectorized mathematical representation of semantic understanding for a user query input or for a defined toxic utterance described in natural language. For example, the text embedding module 265 may employ a Latent Semantic Analysis (LSA) or Latent Dirichlet allocation (LDA) which may define how close each of the observed terms in the received user query input are to various synonyms. As another example, the text embedding module 265 may employ a Word2Vec algorithm, which includes a neural network trained to understand which terms or phrases should be considered closer or further away from certain synonyms or antonyms. As yet another example, the text embedding module 265 may employ a fully recurrent neural network trained to consider the order of terms within the received user query input or the natural language descriptors of the toxic utterances. This may allow for identification of a toxic utterance that includes words that may also be used in non-toxic language.

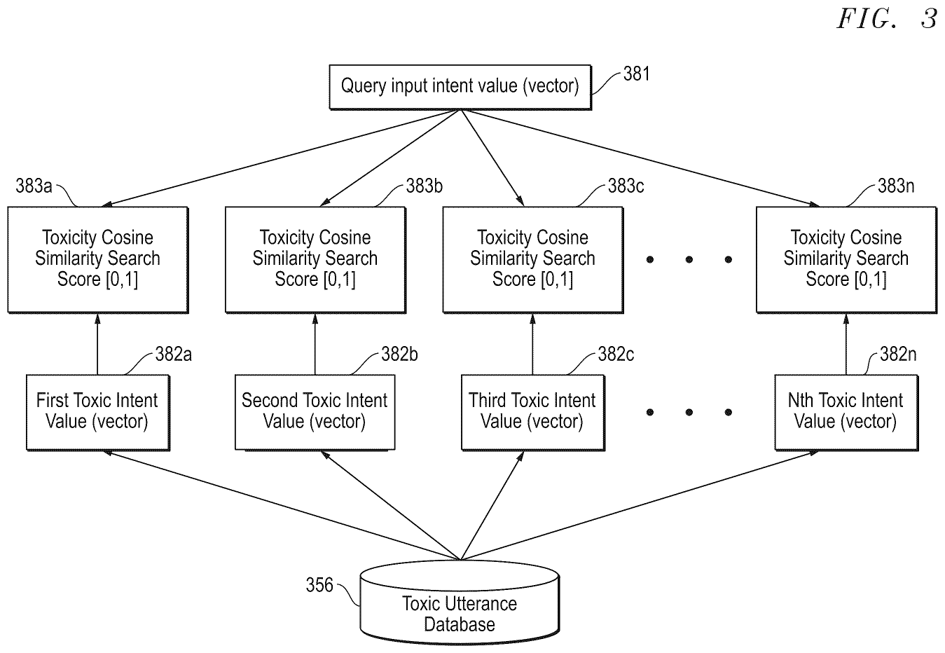

In an embodiment in which the user provides text data to the user conversational interface software application 270, such an intent recognition pipeline machine learning module 261 may truncate this process to exclude processes of the ASR module 263. The hardware processor 202 executing machine-readable code instructions of the intent recognition pipeline machine learning module 261 in an embodiment may apply the text embedding module 265 to generate a query intent value as described and then return the output query intent value of the text embedding module 265 to the query intent to toxicity intent determination module 252. The query intent to toxicity intent module may utilize the similarity search module 280 for a correlation between the query intent value received and a stored toxic intent value in the toxic utterance database 256. Such a similarity search module 280 in an embodiment may perform a cosine semantic similarity search or a weighted cosine semantic similarity search that includes a text frequency-inverse document frequency (TF-IDF) comparison between the received user query input and each of the natural language descriptions of the toxic utterances stored in the toxic utterance database 256, as described in greater detail below with respect to FIGS. 3-5. A user query input may correlate to a natural language descriptions of a defined toxic utterance stored within the toxic utterance database 256 in an embodiment if the toxicity cosine semantic similarity search or the TF-IDF weighted toxicity cosine semantic similarity search provides a highest score in comparison to scores for other toxic utterances, where the highest exceeds a minimum match threshold, such as, for example, 0.1, 0.15, 0.2, or 0.5.

Upon identification that a toxic utterance was used within the received user query input, the hardware processor 202 executing machine-readable code instructions of the OTB AI productivity tool 250 may perform a defined responsive action for that identified toxic utterance, as given within metadata for that identified toxic utterance within the toxic utterance database 256. Alternatively, execution of machine readable code instructions for the query intent to toxicity intent module 252 may determine that no defined toxic utterance has occurred in some embodiments.

In one example, the hardware processor 202 executing code instructions for the query intent to toxicity module 252 for the OTB AI productivity tool 250 may implement a defined responsive action to instruct the user conversational interface software application 270 to provide a defined response to the user, such as informing the user of or admonishing the user for use of such a toxic utterance, or refusal to perform the requested action within the user query input. In other

As another example, the hardware processor 202 executing code instructions for the query intent to toxicity intent module 252 for the OTB AI productivity tool 250 may identify that no toxic utterance occurred or the toxic utterance is of a general type, such as a single curse word used within an otherwise acceptable request for responsive capability of an AI productivity tool enableable software application 211 executing on the information handling system. In either case, the OTB AI productivity tool 250 will still perform an action of a best match capability and in some embodiments generate a defined response with performance of the requested action, as described in greater detail immediately below. In such a scenario, when no toxic utterances or a general type is detected within the user query input, the hardware processor 202 executing code instructions for the query intent to toxicity module 252 for the OTB AI productivity tool 250 may further instruct the AI productivity tool enableable software application 211 to perform the identified action with execution of the best matched capability. In such a way, the hardware processor 202 executing code instructions for the OTB AI productivity tool 250 may identify and provide a defined appropriate response to the use of toxic utterances, if any within received user query inputs.

As described herein, in some cases no toxic utterances are found within the user query, or the toxic utterance identified may be of a general type, such as a single curse word used within an otherwise acceptable request for an AI productivity tool enableable software application 211. In such scenarios, a hardware processor 202 executing code instructions of the OTB AI productivity tool 250 in an embodiment may match the received user query inputs to known capabilities of one or more of the AI productivity tool-enableable software applications 211 through execution by the hardware processor 202 of machine readable code instructions for one or more natural language processing machine learning models. AI productivity tool enableable software application 211 may have or publish a list of recognized “capabilities” or functionalities that it may perform during execution of such an AI productivity tool enableable software application 211 in response to a query input received and processed by the OTB AI productivity tool 250 into a query intent vector value. The capabilities are provided text descriptors that may be processed into vectorized capability intent values in a multi-axis vector space such that these intent value mathematical representations of a query and a capability may be correlated by a similarity matching algorithm to select a capability responsive to an input query from a user. These natural language descriptions of the capabilities for the AI productivity tool-enableable software applications 211 may be stored within a natural language capability database 255 for comparison to received user query inputs, for example, in order to identify a capability most likely to address a user's request within the received user query inputs.

The hardware processor 202 executing machine readable code instructions of the OTB AI productivity tool 250 may determine capability intent values associated with natural language descriptions of the gathered capabilities for each of a plurality of AI productivity tool-enablable software applications 211. These capability intent values are a mathematical representation of the natural language descriptions of capability operations or services from various AI productivity tool-enablable software applications 211 in an embodiment. These capability intent values may be represented by a mathematical value in a multi-axis vector space that may be associated with the natural language description for that capability or intent. In an embodiment, the capabilities may also be associated with an identification (ID) such as an alphanumeric ID that may be stored within a natural language capabilities database 255. Generating such capability intent values as vectors may be a first step in a natural language processing method to determine a capability corresponding to and responsive to the user's intent or requested action within a user query input that takes into account the context or semantics of the words used within the user query input.

In an embodiment, the natural language capabilities database 255 may store a plurality of capabilities associated with each of a plurality of AI productivity tool-enablable software applications 211 with a name, capability ID, natural language descriptor, or a capability intent value in some embodiments. These capabilities stored at the natural language capabilities database 255 may include any input and output capabilities provided by the AI productivity tool-cenablable software applications 211 being executed by the hardware processor 202 or any other hardware processing devices (104 or 106 of FIG. 1). Upon registration of a given capability by the AI productivity tool enableable software application 211 in an embodiment, a hardware processor 202 for the information handling system may execute machine readable code instructions for one or more text embedding algorithms in the text embedding module 265 to generate a multi-dimensional vector capability intent value for that capability that, for example, may be based on text descriptors for that capability. Each of these capability intent values for association with these capabilities may also be associated with an ID such as an alphanumeric ID that may identify, uniquely, these capabilities in the natural language capabilities database 255, for example. These capability intent values may later be used to determine which of the capabilities a user intends to invoke or execute within a received user query input based on similarity with a query intent value, if such a responsive action is permitted, as described in embodiments herein.

When the user provides the user query input, which may or may not also contain toxic utterances as described above, the hardware processor 202 executing machine-readable code instructions of the OTB AI productivity tool 250 in an embodiment may orchestrate assessment of the user's intended goals within the user query input (e.g., what the user wishes to achieve with this communication) with determination of a query input intent value, and identify one or more capabilities associated with the AI productivity tool enableable software application 211 having a correlating capability intent value and that is capable of executing a response to this user query input intent. A user query input may correlate to registered capability for the AI productivity tool enableable software application 211 in an embodiment if the TF-IDF weighted capability cosine semantic similarity search provides a score for that capability that exceeds a minimum match threshold, such as, for example, 0.1, 0.15, 0.2, or 0.5. Further, the OTB AI productivity tool 250 may initiate performance of one or more tasks employing those capabilities to achieve the user-intended results to the user query input. The query intent to capability determination module 253 may utilize the similarity search module 280 for a correlation between the query intent value received and a stored capability intent value. Such a similarity search module 280 in an embodiment may perform a semantic similarity search or a weighted semantic similarity search that includes a text frequency-inverse document frequency (TF-IDF) comparison between the received user query input and each of the gathered natural language capabilities stored in the natural language capabilities database 255, for example.

More specifically, the detected intent having a query intent value in a multi-axis vector space, such as “decrease display brightness,” “speed up my application,” or “send a text message” may be associated with a known capability or functionality of AI productivity tool enableable software application 211 at the information handling system. More specifically, the intent “decrease display brightness” may be associated with a capability for adjusting settings or configurations for a display device (115 of FIG. 1), based on similarity correlation between a query intent value and a capability intent value as determined by the similarity search module 280. As another example, the query intent “speed up my application” may be associated with a capability associated with the AI productivity tool enableable software application 211 for automatically downloading and installing updates for such AI productivity tool enableable software application 211, based on similarity correlation between a query intent value and a capability intent value as determined by the similarity search module 280. In yet another example, the query intent “send a text message” may be associated with a capability of the AI productivity tool enableable software application 211 to automatically generate and transmit text messages, based on similarity correlation between a query intent value and a capability intent value as determined by the similarity search module 280. As described above, these “capabilities” may be registered and associated with a specific AI productivity tool enableable software application 211 at the natural language capabilities database 255 in an embodiment.

Upon identification of a capability that addresses the determined query “intent” of the user within the received user query input, the hardware processor 202 executing machine-readable code instructions of the OTB AI productivity tool 250 may direct execution of one or more processes at the AI productivity tool enableable software application 211 associated with that capability in response to the user query input, if permitted. In the case where the user query input also contains toxic utterances, the OTB AI productivity tool 250 may only execute the identified capability when the identified toxic utterance is of a general, rather than a heightened type, as defined in the metadata for the identified natural language description of the defined toxic utterance stored within the toxic utterance database 256, pursuant to the received, defined toxic utterance policy updates in embodiments herein. Other toxic utterances category types may also be used and any number of toxic utterance category types may be used in various embodiments.

FIG. 3 is a block diagram illustrating a method of identifying a natural language description of a defined toxic utterance that best matches a received user query input by having a toxicity intent value that generates a highest toxicity cosine similarity search score according to an embodiment of the present disclosure. As described herein, a hardware processor may execute machine readable code instructions for a semantic similarity search machine learning model that analyzes and weighs context and relevancy.

For example, in embodiments herein, a hardware processor may execute machine readable code instructions for a semantic similarity search machine learning model, via a query intent to toxicity intent module, that compares the vectorized user query input intent value 381 and the toxicity intent values 382a, 382b, 382c, to 382n stored within the toxic utterance database 356. Such a comparison may be performed using a semantic search machine learning model, such as with a cosine or other semantic similarity search algorithm, that compares the distance or value difference in a multi-axis vector space between two vectors (e.g., 381 and each of 382a, 382b, 382c, to 382n) to determine the contextual similarity between the natural language description of the toxic utterances having the toxicity intent values 382a to 382n and the natural language user query input having an user query input intent value 381 generated from an embedded text algorithm. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate toxic intent and query intent vector values. The toxicity cosine similarity search comparison or other semantic similarity search algorithm may be performed for several of the toxicity intent values (such as 382a, 382b, 382c, to 382n) stored within the toxic utterance database 356 to identify a toxicity intent value (e.g., 382a) that most closely matches the user query input value 381, and exceeds a minimum matching threshold, according to embodiments herein.

As described herein, natural language descriptions of defined toxic utterances stored within the toxic utterance database 356 may be processed into toxicity intent values in a multi-axis vector space, such as (such as 382a, 382b, 382c, to 382n). These toxicity intent values are mathematical representations that may be correlated by the semantic similarity search to identify usage of a toxic utterance within a user query input having a user query input value 381. Any number of axes for the multi-axis vector spaces may be used in various embodiments. Indeed, many toxicity intent value generators or other machine learning text embedding algorithms for determining toxicity intent vector values for natural language terms or phrases and contemplated for use in embodiments herein utilize toxicity intent vector values that might be plotted among plural axes well above the three axis multi-axis vector spaces. For example, multi-axis vector spaces having 500 to 700 or more axes are contemplated for use with the machine learning text embedding algorithms with embodiments herein.

Each axis of the multi-axis vector space may provide a measurement of various attributes of a text excerpt that are known to provide context or semantic understanding of the text. For example, an axis of the multi-axis vector space may represent a reader's understanding of a given text excerpt may depend upon the reader's knowledge of any given word's meaning within the text, identified phrases within the text, or the understood order or sequence of words within the text. More specifically, an axis of the multi-axis vector space may represent the reader's understanding is enhanced by the reader having a larger vocabulary and understanding of which words in that vocabulary are synonyms (closer in meaning) to a given word in that text, and which words are antonyms (further away in meaning) to that given word. As another example, an axis of the multi-axis vector space may represent the reader's ability to identify common phrases, such as “in other words” may provide greater insight to the semantic meaning of a text excerpt using this phrase than the reader's understanding of each of the words “in,” “other,” and “words” used separately from one another. As yet another example, an axis of the multi-axis vector space may represent the importance of the order of certain words in an excerpt may impact semantic meaning of the excerpt. More specifically, the phrase “man bites dog” may have a completely different semantic or contextual meaning than the phrase “dog bites man,” although cach phrase has the same words, just in a different order. Thus, the text embedding algorithm system's ability to incorporate values and identify common phrases of words grouped together and the importance of word order with the value of the generated vector intent value for a toxic utterance or query adds to the semantic meaning of a text excerpt using such a phrase to distinguish the semantic meaning in the generated vector intent value. Thus, the semantic similarity machine learning model algorithm may more accurately identify similarities of unique query intent values with toxicity intent values in embodiments herein.

Each axis of the multi-axis vector space, and thus, each value within a vector within such a multi-axis vector space may provide a measurement of these various attributes within a given intent value in embodiments herein. For example, a vector for a user query input intent value or for toxicity intent value may provide a measurement of similarity between any given word within the user query input or natural language description of a defined toxic utterance, respectively, a measurement of dissimilarity with known antonyms, identification of any given word as part of a phrase, or usage of any given word in a specific order that is known to be of importance. In such a way, the vectorized user query input intent value 381 and toxicity intent values (such as 382a, 382b, 382c, to 382n) may mathematically represent a reader's contextual or semantic understanding of the user query input and the natural language descriptors for the defined toxic utterances. These vectors may then be compared to one another in order to understand, not only which individual words are used and their frequencies (as determined through TF-IDF comparison), but also how alike various phrases within the user query input and toxic utterances are, and how alike the usage of those words and phrases are to provide a context, such as influenced by the order of those words or phrases and their relation to one another.

Several text embedding algorithms may be used in various embodiments herein in order to provide such a mathematical representation of semantic understanding. For example, the text embedding module (265 of FIG. 2) may employ a Latent Semantic Analysis (LSA) or Latent Dirichlet allocation (LDA) which may define how close each of the observed terms in the received user query input are to various synonyms. As another example, the text embedding module (265 of FIG. 2) may employ a Word2Vec algorithm, which includes a neural network trained to understand which terms or phrases should be considered closer or further away from certain synonyms or antonyms. As yet another example, the text embedding module (265 of FIG. 2) may employ a fully recurrent neural network trained to consider the order of terms within the received user query input or the natural language descriptors of the toxic utterances.

A hardware processor executing machine readable code instructions for a semantic search machine learning model of the similarity search module (e.g., 280 of FIG. 2) may determine a distance, that is an angular or other value difference of the vector intent values within the multi-axis vector space between the query input intent value 381 and each of a plurality of toxicity intent values 382a to 382n. Then, for each of those determined distances, the hardware processor executing machine readable code instructions for a semantic search machine learning model of the similarity search module (e.g., 280 of FIG. 2) may determine an angular similarity having a value between zero and one for the query input intent value 381 and each of a plurality of toxicity intent values 382a to 382n. This angular similarity value in an embodiment may comprise the toxicity cosine semantic similarity search score (e.g., 383a, 383b, 383c to 383n) for a given toxicity intent value (e.g., 382a, 382b, 382c to 382n, respectively), where zero is a worst match and one is a best match between the given toxicity intent value (e.g., 382a, 382b, 382c to 382n) and the query input intent value 381. In such a way, a hardware processor executing code instructions for the query intent to toxicity intent module for the OTB AI productivity tool may take relevance and context of natural language within a user query input into account when determining a matching toxic utterance given within the user query input.

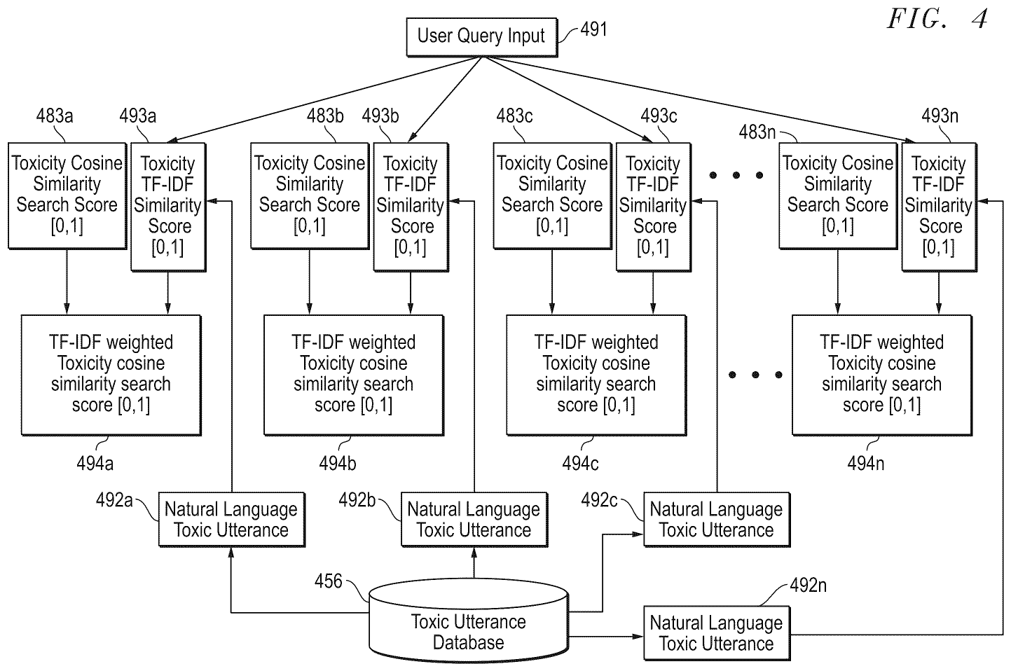

FIG. 4 is a block diagram illustrating a method of identifying a defined toxic utterance that best matches a received user query input by weighting a semantic similarity search score by a text frequency-inverse document frequency (TF-IDF) similarity search score for the defined toxic utterance according to an embodiment of the present disclosure. As described herein, while semantic search methodologies, such as that described above with respect to FIG. 3 are better-suited than TF-IDF methodologies alone for use with natural language text excerpts for context accuracy, such as for the user query input 491 and the natural language descriptions of toxic utterances 492a through 492n, TF-IDF methodologies are better-suited than semantic search methodologies where a single keyword within the user query input 491 is important to identifying a matching toxic utterance (e.g., 492a, 492b, 492c, up to 492n). It may be useful to also perform a TF-IDF comparison for the user query input 491 across the stored natural language descriptions of the toxic utterances (e.g., 492a, 492b, 492c to 492n) within the toxic utterance database 456 to identify a matching toxic utterance given within the user query input 491.

As described herein, in order to increase the accuracy of the toxicity cosine or other semantic similarity search scores, such as 383a to 383n of FIG. 3 above in determining when a toxic utterance has been used within a received user query input, the hardware processor executing machine readable code instructions for the query intent to capability determination module of the OTB AI productivity tool in an embodiment may, for each compared user query input 491 and natural language toxic utterance 492a to 492n, perform a TF-IDF comparison. For example, as shown in FIG. 4, and as part of the toxicity similarity search described above with reference to FIG. 3, the hardware processor executing machine readable code instructions for the similarity search module may determine the toxicity cosine or other semantic similarity search score 483a describing a degree of similarity correlation between the query input intent value (381 of FIG. 3) for the user query input 491 and the toxicity intent value (382a of FIG. 3) for a natural language description of a toxic utterance 492a stored within the toxic utterance database 456. As another example, the hardware processor executing machine readable code instructions for the similarity search module may determine the toxicity cosine or other semantic similarity search score 483b describing a degree of similarity between the query input intent value (381 of FIG. 3) for the user query input 491 and the toxicity intent value (382b of FIG. 3) for a natural language description of a toxic utterance 492b stored within the toxic utterance database 456. In yet another example, the hardware processor executing machine readable code instructions for the similarity search module may determine the toxicity cosine or other semantic similarity search score 483c describing a degree of similarity between the query input intent value (381 of FIG. 3) for the user query input 491 and the toxicity intent value (382c of FIG. 3) for a natural language description of a toxic utterance 492c stored within the toxic utterance database 456. This may be repeated for each of the natural language capabilities (e.g., up to 492n) stored within the toxic utterance database 456, to produce a toxicity cosine or other semantic similarity search score of 483n.

In an embodiment, each of these toxicity cosine similarity search scores 482a to 482n may then be weighted by a TF-IDF similarity score (e.g., 493a to 493n, respectively), in order to increase the accuracy of the toxicity cosine similarity or other semantic search scores 483a to 483n in determining when a toxic utterance (e.g., 492a to 492n) has been used within the received user query input 491. For example, the hardware processor executing code instructions for the similarity search module (280 of FIG. 2) may perform a TF-IDF algorithm to measure the frequency with which each of a plurality of natural language terms appear within the user query input 491, as weighted by the frequency with which that term occurs in one of each of the natural language toxic utterances 492a to 492n stored within the toxic utterance database 456. More specifically, the hardware processor executing code instructions for a TF-IDF algorithm may determine a TF-IDF similarity score 493a measuring the frequency with which each of a plurality of natural language terms appear in the user query input 491, as weighted by the frequency with which each of those terms also occur within the natural language toxic utterance 492a. As another example, the hardware processor executing code instructions for a TF-IDF algorithm may determine a TF-IDF similarity score 493b measuring the frequency with which each of a plurality of natural language terms appear in the user query input 491, as weighted by the frequency with which each of those terms occur within the natural language toxic utterance 492b. In yet another example, the hardware processor executing code instructions for a TF-IDF algorithm may determine a TF-IDF similarity score 493c measuring the frequency with which each of a plurality of natural language terms appear in the user query input 491, as weighted by the frequency with which each of those terms occur within the natural language toxic utterance 492c. This may be repeated for each of the natural language toxic utterances (e.g., up to 492n) stored within the toxic utterance database 456, to produce a TF-IDF similarity search score of 493n. Each TF-IDF similarity score determined in such a way may have a value between zero and one. It is contemplated that any number of known or later-developed TF-IDF comparison algorithms may be used, including the best-match 25 (BM25) algorithm, the Okapi BM25 algorithm, and the BM-25 with fields (BM-25F).

Each of the toxicity cosine or other semantic similarity search scores 483a to 483n output of the semantic search comparison is weighted by one of the TF-IDF similarity search scores 493a to 493n, respectively, for each natural language toxic utterance 492a to 492n, respectively, that is compared to the user query input 491, via the hardware processor executing machine readable code instructions of the query intent to toxic intent determination module. For example, the toxicity cosine or other semantic similarity search scores 483a to 483n may be multiplied by the TF-IDF similarity search scores 493a to 493n, respectively in an embodiment. In another embodiment, the toxicity cosine or other semantic similarity search scores 483a to 483n may be multiplied by the TF-IDF similarity search scores 493a to 493n further modified by a TF-IDF weighting coefficient or fraction to further adjust the TF-IDF weighting, respectively in an embodiment. In another example embodiment, a TF-IDF weighted toxicity cosine or other semantic similarity search score 494a may be determined by a hardware processor executing code instructions of the query intent to toxicity intent determination module as equivalent to one plus the toxicity cosine or other semantic similarity search score 483a, multiplied by one plus the TF-IDF similarity search score 493a. In still another example embodiment, a TF-IDF weighted toxicity cosine or other semantic similarity search score 494b may be determined by a hardware processor executing code instructions of the query intent to toxic intent determination module as equivalent to one plus the toxicity cosine or other semantic similarity search score 483b, multiplied by one plus the TF-IDF similarity search score 493b. In yet another example embodiment, a TF-IDF weighted toxicity cosine or other semantic similarity search score 494c may be determined by a hardware processor executing code instructions of the query intent to toxic intent determination module as equivalent to one plus the toxicity cosine or other semantic similarity search score 483c, multiplied by one plus the TF-IDF similarity search score 493c. This may be repeated for each of the natural language toxic utterances (e.g., up to 492n) stored within the toxic utterance database 456, to produce a TF-IDF weighted or other toxicity cosine semantic similarity search score of 494n.

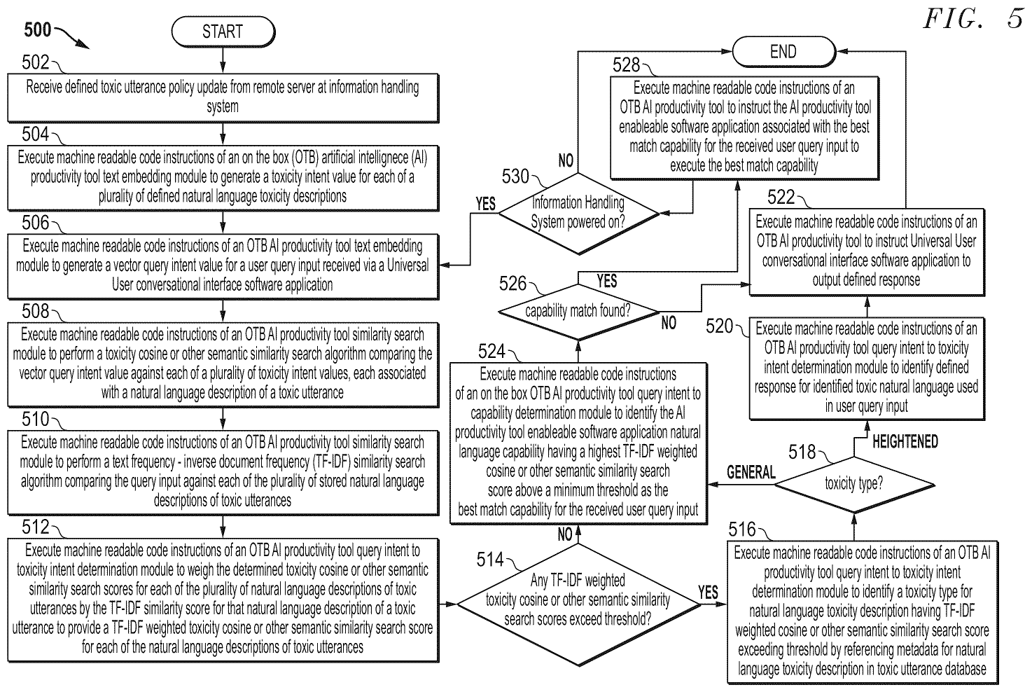

FIG. 5 is a flowchart 500 showing a method of identifying a defined toxic utterance that best matches a received user query input through a text frequency-inverse document frequency (TF-IDF) weighted semantic search that considers context of toxic terms as well as keywords, if any, within the user query input according to an embodiment of the present disclosure. It is appreciated that the method 500 described herein may be executed via execution of computer readable program code instructions in firmware or software by a hardware processor or other hardware processing device on an information handling system.

The method 500 may include, at block 502, receiving a defined toxic utterance policy update from a remote server at the information handling system. For example, an information technology decision maker (ITDM) for the operator of the on the box (OTB) artificial intelligence (AI) productivity tool in an embodiment may routinely update one or more policies defining toxic utterances, natural language descriptions of the toxic utterances, their types, and proper responses to user query inputs that include the toxic utterances. Such policies, when updated, may be transmitted to the OTB AI productivity tool from a remote server, via a network in an embodiment.

The method 500 at block 504 may include executing machine readable code instructions of an on the box (OTB) artificial intelligence (AI) productivity tool text embedding module, via a hardware processor, to generate a toxicity intent value for each of a plurality of defined natural language toxicity descriptions. In some embodiments, these toxicity intent values may be generated at the remote server where an ITDM may update policies for toxic utterances, as described above with respect to block 502. In another example embodiment described with respect to FIG. 2, the hardware processor 202 executing machine readable code instructions for a toxic intent value generator 254 of the OTB AI productivity tool 250 may determine toxic intent values associated with natural language descriptions of the defined toxic utterances stored in the toxic utterance database 256. These toxicity intent values, as generated at the OTB AI productivity tool 250 or received within policy updates via a remote server are a mathematical representation of the natural language descriptions of the defined toxic utterances in an embodiment. These toxicity intent values may be represented by a mathematical value in a multi-axis vector space that may be associated with the natural language description for that defined toxic utterance. Generating such toxicity intent values as vectors may be a first step in a natural language processing method to determine when a toxic utterance has been used within a user query input that takes into account the context or semantics of the words used within the user query input.

The hardware processor executing machine readable code instructions at block 506 of an OTB AI productivity tool text embedding module in an embodiment may generate a vector query intent value for a user query input received via a user conversational interface software application. For example, a user may provide text or voice data (e.g., via IO device 116, or microphone 118 of FIG. 1) to a universal user conversational interface, operating as a chatbot to simulate a conversation between the user and any of several AI productivity tool enableable software applications. In another example embodiment described at FIG. 2, the hardware processor 202 executing machine readable code instructions of the OTB AI productivity tool 250 in an embodiment may receive a user query input, via the user conversational interface software application 270 or other interface requesting that an action be taken at the information handling system. In an embodiment in which the user provides a user query input in the form of voice data to the AI productivity tool enableable software application 211 via the OTB AI productivity tool 250 and the user conversational interface software application 270, the hardware processor 202 executing machine-readable code instructions of an automated speech recognition (ASR) module 263 to detect words within the recorded voice data and convert them to text. The hardware processor 202 may also execute machine readable code instructions of a text embedding module 265 to detect which of these words are nouns, verbs, or commonly used sentence structures and generate a vectorized query input intent value for the user query input.

At block 508 in an embodiment, the hardware processor may execute machine readable code instructions of an OTB AI productivity tool similarity search module to perform a cosine or other semantic similarity search algorithm comparing the vector query intent value against each of a plurality of toxicity intent values, each associated with a natural language description of a toxic utterance. For example, in an embodiment described with respect to FIG. 2, in some cases the received user query inputs may include some form of toxic language defined within the toxic utterance database 256. In order to detect the use of such toxic language, the hardware processor 202 executing machine-readable code instructions of the query intent determination module 251 may receive the user query input via microphone, image, or text input, and initiate execution of machine readable code instructions for an intent recognition pipeline machine learning module 261. In an embodiment, an automatic speech recognition (ASR) module 263, a text embedding module 265, or a similarity search module 280 may work in various combinations with one another to detect a user's audio speech input, convert to text or detect text, and detect a toxicity intent value or the use of toxic language correlated to a query intent vector value from the text of the user query input received from the universal user conversational interface software application 270 or other interface. In an embodiment in which the user provides text data to the user conversational interface software application 270, such an intent recognition pipeline machine learning module 261 may truncate this process to exclude processes of the ASR module 263.

The hardware processor 202 executing machine-readable code instructions of the intent recognition pipeline machine learning module 261 in an embodiment may apply the text embedding module 265 to generate a query intent value as described and then return the output query intent value from the text embedding module 265 to the query intent to toxicity intent determination module 252. The query intent to toxicity intent module may utilize the similarity search module 280 for a correlation between the query intent value received and a stored toxic intent value. Such a similarity search module 280 in an embodiment may perform a cosine semantic similarity search or a performs weighted cosine semantic similarity search that includes a text frequency-inverse document frequency (TF-IDF) comparison described in block 510 below between the received user query input and each of the natural language descriptions of the toxic utterances stored in the toxic utterance database 256.

In another example embodiment described with respect to FIGS. 2 and 3, a hardware processor may execute machine readable code instructions for a semantic similarity search machine learning model, via a query intent to toxicity intent module, that compares the vectorized user query input intent value 381 and the toxicity intent values 382a-382n stored within the toxic utterance database 356. Such a comparison may be performed using a semantic search machine learning model, such as a cosine or other semantic similarity search algorithm that compares the angular difference or distance or value difference in a multi-axis vector space between two vectors (e.g., 381 and cach of 382a, 382b, 382c, to 382n) to determine the contextual similarity between the natural language description of the toxic utterances having the toxicity intent values 382a to 382n and the natural language user query input having an user query input intent value 381 generated from an embedded text algorithm. The toxicity cosine similarity search comparison or other semantic similarity search algorithm may be performed for several of the toxicity intent values (such as 382a, 382b, 382c, to 382n) stored within the toxic utterance database 356 to identify a toxicity intent value (e.g., 382a) that most closely matches the user query input value 381, and exceeds a minimum matching threshold, according to embodiments hercin.

As described herein, natural language descriptions of defined toxic utterances stored within the toxic utterance database 356 may be processed into toxicity intent values, such as (such as 382a, 382b, 382c, to 382n) in a multi-axis vector space, such that these intent value mathematical representations may be correlated by a semantic similarity search to identify usage of a toxic utterance within a user query input having a user query input value 381. Each axis of the multi-axis vector space, and thus, each value within a vector within such a multi-axis vector space may provide a measurement of various attributes within a given intent value in embodiments herein. For example, a vector for a user query input intent value or for toxicity intent value may provide a measurement of similarity between any given word within the user query input or natural language description of a defined toxic utterance, respectively, a measurement of dissimilarity with known antonyms, identification of any given word as part of a phrase, or usage of any given word in a specific order that is known to be of importance among other semantics attributes. In such a way, the vectorized user query input intent value 381 and toxicity intent values (such as 382a, 382b, 382c, to 382n) may mathematically represent a reader's contextual or semantic understanding of the user query input and the natural language descriptors for the defined toxic utterances. These vectors may then be compared to one another in order to understand, not only which individual words are used and their frequencies (as determined through TF-IDF comparison), but also how alike various phrases within the user query input and correlate with toxic utterances, and how alike the usage of those words and phrases are to provide a context, such as influenced by the order of those words or phrases and their relation to one another.

A hardware processor executing machine readable code instructions for a semantic search machine learning model of the similarity search module 280 may determine a distance, that is a value difference of the vector intent values within the multi-axis vector space between the query input intent value 381 and each of a plurality of toxicity intent values 382a to 382n. Then, for each of those determined distances, the hardware processor executing machine readable code instructions for a semantic search machine learning model of the similarity search module 280 may determine an angular similarity having a value between zero and one for the query input intent value 381 and each of a plurality of toxicity intent values 382a to 382n. This angular similarity value in an embodiment may comprise the toxicity cosine similarity search score (e.g., 383a, 383b, 383c to 383n) for a given toxicity intent value (e.g., 382a, 382b, 382c to 382n, respectively), where zero is a worst match and one is a best match between the given toxicity intent value (e.g., 382a, 382b, 382c to 382n) and the query input intent value 381. In such a way, a hardware processor executing code instructions for the query intent to toxicity intent module for the OTB AI productivity tool may take relevance and context of natural language within a user query input into account when determining a correlation to a matching toxic utterance given within the user query input.

The hardware processor in an embodiment at block 510 may execute machine readable code instructions of an OTB AI productivity tool similarity search module to perform a text frequency-inverse document frequency (TF-IDF) similarity search algorithm comparing the query input against each of the plurality of stored natural language descriptions of toxic utterances. As described herein, while semantic search methodologies are better-suited than TF-IDF methodologies alone for use with natural language text excerpts for context accuracy, TF-IDF methodologies are better-suited than semantic search methodologies where a single keyword within the user query input is important to identifying a matching toxic utterance. For example, in embodiments described with respect to FIG. 4, the hardware processor executing machine readable code instructions for the query intent to capability determination module of the OTB AI productivity tool in an embodiment may, for cach compared user query input 491 and natural language toxic utterance 492a to 492n, perform a TF-IDF comparison. First, the hardware processor executing computer readable code instructions for a similarity search ML model algorithm determines semantic similarity search scores. More specifically, the hardware processor executing machine readable code instructions for the similarity search module may determine the toxicity cosine or other semantic similarity search score 483a describing a degree of similarity between the query input intent value for the user query input 491 and the toxicity intent value for a natural language description of a toxic utterance 492a stored within the toxic utterance database 456. As another example, the hardware processor executing machine readable code instructions for the similarity search module may determine the toxicity cosine or other semantic similarity search score 483b describing a degree of similarity between the query input intent value for the user query input 491 and the toxicity intent value for a natural language description of a toxic utterance 492b stored within the toxic utterance database 456. In yet another example, the hardware processor executing machine readable code instructions for the similarity search module may determine the toxicity cosine or other semantic similarity search score 483c describing a degree of similarity between the query input intent value 381 for the user query input 491 and the toxicity intent value for a natural language description of a toxic utterance 492c stored within the toxic utterance database 456. This may be repeated for each of the natural language capabilities (e.g., up to 492n) stored within the toxic utterance database 456, to produce a toxicity cosine or other semantic similarity search score of 483n.

In an embodiment, each of these toxicity cosine similarity search scores 482a to 482n may then be weighted by a TF-IDF similarity score (e.g., 493a to 493n, respectively), in order to increase the accuracy of the toxicity cosine similarity or other semantic search scores 483a to 483n in determining when a toxic utterance (e.g., 492a to 492n) has been used within the received user query input 491. For example, the hardware processor executing code instructions for the similarity search module 280 may perform a TF-IDF algorithm to measure the frequency with which each of a plurality of natural language terms appear within the user query input 491, as weighted by the frequency with which that term occurs in one of each of the natural language toxic utterances 492a to 492n stored within the toxic utterance database 456. More specifically, the hardware processor executing code instructions for a TF-IDF algorithm may determine a TF-IDF similarity score 493a measuring the frequency with which each of a plurality of natural language terms appear in the user query input 491, as weighted by the frequency with which each of those terms also occur within the natural language toxic utterance 492a. As another example, the hardware processor executing code instructions for a TF-IDF algorithm may determine a TF-IDF similarity score 493b measuring the frequency with which each of a plurality of natural language terms appear in the user query input 491, as weighted by the frequency with which each of those terms occur within the natural language toxic utterance 492b. In yet another example, the hardware processor executing code instructions for a TF-IDF algorithm may determine a TF-IDF similarity score 493c measuring the frequency with which each of a plurality of natural language terms appear in the user query input 491, as weighted by the frequency with which each of those terms occur within the natural language toxic utterance 492c. This may be repeated for each of the natural language toxic utterances (e.g., up to 492n) stored within the toxic utterance database 456, to produce a TF-IDF similarity search score of 493n. Each TF-IDF similarity score determined in such a way may have a value between zero and one in some embodiments but may depend on lexical algorithm used. It is contemplated that any number of known or later-developed TF-IDF comparison algorithms may be used, including the best-match 25 (BM25) algorithm, the Okapi BM25 algorithm, and the BM-25 with fields (BM-25F).

At block 512 in an embodiment, the hardware processor may execute machine readable code instructions of an OTB AI productivity tool query intent to toxicity intent determination module to weigh the determined toxicity cosine or other semantic similarity search scores for each of the plurality of natural language descriptions of toxic utterances by the TF-IDF similarity score for that natural language descriptions of toxic utterances to provide a TF-IDF weighted toxicity cosine or other semantic similarity search score for each of the natural language descriptions of toxic utterances. For example, each of the toxicity cosine or other semantic similarity search scores 483a to 483n output of the semantic search comparison is weighted by one of the TF-IDF similarity search scores 493a to 493n, respectively, for each natural language toxic utterance 492a to 492n, respectively, that is compared to the user query input 491, via the hardware processor executing machine readable code instructions of the query intent to toxic intent determination module. More specifically, the toxicity cosine or other semantic similarity search scores 483a to 483n may be multiplied by the TF-IDF similarity search scores 493a to 493n, respectively in an embodiment. In some embodiments, a TF-IDF weighting coefficient or fraction may be used to further adjust the TF-IDF weighting. In another example embodiment, a TF-IDF weighted toxicity cosine or other semantic similarity search score 494a may be determined by a hardware processor executing code instructions of the query intent to toxicity intent determination module as equivalent to one plus the toxicity cosine or other semantic similarity search score 483a, multiplied by one plus the TF-IDF similarity search score 493a. In still another example embodiment, a TF-IDF weighted toxicity cosine or other semantic similarity search score 494b may be determined by a hardware processor executing code instructions of the query intent to toxic intent determination module as equivalent to one plus the toxicity cosine or other semantic similarity search score 483b, multiplied by one plus the TF-IDF similarity search score 493b. In yet another example embodiment, a TF-IDF weighted toxicity cosine or other semantic similarity search score 494c may be determined by a hardware processor executing code instructions of the query intent to toxic intent determination module as equivalent to one plus the toxicity cosine or other semantic similarity search score 483c, multiplied by one plus the TF-IDF similarity search score 493c. This may be repeated for each of the natural language toxic utterances (e.g., up to 492n) stored within the toxic utterance database 456, to produce a TF-IDF weighted or other toxicity cosine semantic similarity search score of 494n.

It may be determined in an embodiment at block 514 whether any TF-IDF weighted toxicity cosine or other semantic similarity search scores exceed a toxicity match threshold. For example, as described with reference to FIG. 2, a user query input may correlate to a natural language descriptions of a defined toxic utterance stored within the toxic utterance database 256 in an embodiment if the toxicity cosine semantic similarity search or TF-IDF weighted toxicity cosine semantic similarity search provides a highest score in comparison to scores for other toxic utterances, where the highest exceeds a minimum match threshold, such as, for example, 0.1, 0.15, 0.2, or 0.5. It is contemplated that any threshold may be used relative to the TF-IDF weighted toxicity cosine semantic similarity search scoring scale used or depending on the desired sensitivity in embodiments herein. If a TF-IDF weighted toxicity cosine or other semantic similarity search score exceeds a toxicity match threshold, this may indicate that the natural language description of the defined toxic utterance having the highest TF-IDF weighted toxicity cosine or other semantic similarity search score appears within the received user query input. In such a case, the method may proceed to block 516 for determination of a toxicity type for the natural language description of the toxic utterance having the highest TF-IDF weighted toxicity cosine or other semantic similarity search score, which may influence the response provided to the user. If a TF-IDF weighted toxicity cosine or other semantic similarity search score does not exceed a toxicity match threshold, this may indicate that the natural language description of the defined toxic utterance having the highest TF-IDF weighted toxicity cosine or other semantic similarity search score or any defined toxic utterance in the toxic utterance database does not likely appear within the received user query input. In such a case, the method may proceed to block 524 for determination as to whether the user query input includes a request for an action that correlates to a registered capability for the AI productivity tool enableable software application.

At block 516, in an embodiment in which a TF-IDF weighted toxicity cosine or other semantic similarity search score for a specific defined toxic utterance exceeds a toxicity match threshold, a hardware processor may execute machine readable code instructions of an OTB AI productivity tool query intent to toxicity intent determination module to identify a toxicity type for a natural language description of that defined toxic utterance having a highest cosine or other semantic similarity search score or a TF-IDF weighted cosine or other semantic similarity search score by referencing metadata for the natural language description of the toxic utterance in the toxic utterance database. For example, as described in an embodiment with respect to FIG. 2, cach natural language description of a toxic utterance stored in the toxic utterance database 256 may include metadata identifying a type describing the severity of the toxic utterance, such as heightened or general, as well as a defined response for each type. For example, toxic utterances having a heightened type may include specific phrases, or offensive remarks regarding religion, gender, sexual-orientation, or race, while single curse words or less profane language may be given a general type. Any categorization may be used and any number of toxicity type categorizations may be used in various embodiments herein.

In an example embodiment, it may be determined at block 518 in an embodiment, via execution of machine readable code instructions of the OTB AI productivity tool by a hardware processor, which toxicity type has been assigned to the toxic utterance identified at block 514 as matching a user query input. The type of toxic utterance, as defined within metadata may influence the response provided to the user conversational interface software application 270 in an embodiment. If the toxicity type is defined as heightened, the method may proceed to block 520 to identify the defined response for the identified matching toxic utterance. If the toxicity type is defined as general, the method may proceed to block 524 to determine whether the toxic utterance has been used within a user query input that also includes an otherwise acceptable request by the user to perform an action achievable by the AI productivity tool enableable software application and a defined response, if any is designated.

At block 520, in an embodiment in which the toxicity type is defined as heightened, the hardware processor may execute machine readable code instructions of an OTB AI productivity tool query intent to toxicity intent determination module to identify a defined response for the identified toxic utterance used in the user query input. For example, metadata for the identified toxic utterance, as stored within the toxic utterances database 256 may associate a heightened type of toxic utterance with a defined response to inform the user that she has included unacceptable or offensive language, or to admonish the user for use of such toxic language, and may further include notification of refusal to accommodate the request. The defined response may also include an instruction to be sent to the OTB AI productivity tool to prohibit determination or execution of any responsive capabilities of AI productivity tool-enableable software applications in response to the user query input in embodiments.

In an embodiment at block 522, the hardware processor may execute machine readable code instructions of an OTB AI productivity tool to instruct the user conversational interface software application to output the defined response. For example, the hardware processor may execute machine readable code instructions of an OTB AI productivity tool to instruct the user conversational interface software application to output a defined response to inform the user that she has included unacceptable or offensive language, or to admonish the user for use of such toxic language, and may further include notification of refusal to accommodate the request when the toxicity type is heightened. A defined response may further include issuing an instruction to the OTB AI productivity tool prohibiting determination or execution of any responsive capabilities of AI productivity tool-enableable software applications in response to the user query input in embodiments where the toxicity type is heightened. In yet another example in which the toxic utterance is of a general type but is also not contained within an otherwise acceptable request for the AI productivity tool enableable software application to perform an action as determined from no matching capability at block 526, the defined response may be to inform the user that the requested action cannot be taken. The method for identifying a defined toxic utterance that best matches a received user query input through a text frequency-inverse document frequency (TF-IDF) weighted semantic search that considers context of toxic terms as well as keywords within the user query input may then end.

Returning to block 524, in an embodiment in which a TF-IDF weighted toxicity cosine or other semantic similarity search score does not exceed a toxicity match threshold, or in which a toxic utterance having a TF-IDF weighted toxicity cosine or other semantic similarity search score that exceeds the toxicity match is of a general type, the hardware processor may execute machine readable code instructions of an OTB AI productivity tool query intent to capability determination module to identify the AI productivity tool enableable software application natural language capability having a highest TF-IDF weighted cosine or other semantic similarity search score above a minimum threshold as the best match capability for the received user query input. As described herein, a general type of toxic utterance, such as a single curse word used within an otherwise acceptable request for an AI productivity tool enableable software application executing on the information handling system execute a capability to perform an action responsive to a user query input. Block 524 includes searching to determine whether the received user query input includes such an action.

For example, a hardware processor executing code instructions of the OTB AI productivity tool in an embodiment may match the received user queries, or user query inputs to known capabilities of one or more of the AI productivity tool-enableable software applications through execution by the hardware processor of machine readable code instructions for one or more natural language processing machine learning model algorithms. AI productivity tool enableable software application may have or publish a list of recognized “capabilities” or functionalities that it may perform during execution of such an AI productivity tool enableable software application in response to a query input received and processed by the OTB AI productivity tool into a query intent vector value. These capabilities stored at the natural language capabilities database may include any input and output capabilities provided by the AI productivity tool-enablable software applications being executed by the hardware processor or any other hardware processing devices. These natural language descriptions of the capabilities for the AI productivity tool-enableable software applications may be stored within a natural language capability database for comparison to received user query inputs, for example, in order to identify a capability most likely to address a user's request within the received user query inputs.

Upon registration of a given capability by the AI productivity tool enableable software application in an embodiment, a hardware processor for the information handling system may execute machine readable code instructions for one or more text embedding algorithms in the text embedding module to generate a multi-dimensional vector capability intent value for that capability that, for example, may be based on text descriptors for that capability. The capabilities are provided text descriptors that may be processed into vectorized capability intent values in a multi-axis vector space such that these intent value mathematical representations of a query and a capability may be correlated by a similarity matching algorithm to select a capability responsive to an input query from a user.

When the user provides the user query input, which may or may not also contain toxic utterances as described above, the hardware processor executing machine-readable code instructions of the OTB AI productivity tool in an embodiment may orchestrate assessment of the user's intended goals within the user query input (e.g., what the user wishes to achieve with this communication) with determination of a query input intent value, and identify one or more capabilities associated with the AI productivity tool enableable software application having a correlating capability intent value and that is capable of executing a response to this user query input intent. Execution of computer readable code instructions of the query intent to capability determination module may utilize the similarity search module for a correlation between the query intent value received and a stored capability intent value. Such a similarity search module in an embodiment may perform a semantic similarity search or a weighted semantic similarity search that includes a text frequency-inverse document frequency (TF-IDF) comparison between the received user query input and each of the gathered natural language capabilities stored in the natural language capabilities database, for example.

At block 526, it may be determined whether any registered natural language capability for an AI productivity tool enableable software application has a highest capabilities cosine semantic or other similarity search score compared with a user query input and that exceeds the minimum capabilities match threshold. A user query input may correlate to a registered capability for the AI productivity tool enableable software application 211 in an embodiment if the capability cosine semantic similarity search or TF-IDF weighted capability cosine semantic similarity search provides a score for that capability that exceeds a minimum match threshold, such as, for example, 0.1, 0.15, 0.2, or 0.5. Any minimum match threshold may be used in embodiments herein. If a registered natural language capability for an AI productivity tool enableable software application has a highest capabilities cosine semantic or other similarity search score that exceeds the minimum capabilities match threshold, this may indicate that the received user query input, that may also have been identified as containing a toxic utterance or not toxic utterance, may contain an otherwise valid request for the AI productivity tool enableable software application to perform an action. In such a scenario, the method may proceed to block 528 for performance of the matching capability. If no registered natural language capability for an AI productivity tool enableable software application has a capabilities cosine semantic or other similarity search score that exceeds the minimum capabilities match threshold, this may indicate that the user query input, which may or may not have been identified as containing a toxic utterance, does not also contain an otherwise valid request for the AI productivity tool enableable software application to perform an action. In such a scenario, the method may proceed to block 522 for providing a response to the user via the conversational interface software application that the requested action cannot be taken.

The hardware processor in an embodiment at block 528 may execute machine readable code instructions of an OTB AI productivity tool to instruct the AI productivity tool enableable software application associated with the best match capability for the received user query input to execute the best match capability. For example, in an embodiment described with respect to FIG. 2, the hardware processor executing machine readable code instructions of the OTB AI productivity tool determines that the best match capability is associated with the AI productivity tool enableable software application 211, the hardware processor 202 may execute machine readable code instructions of the OTB AI productivity tool 250 to instruct the AI productivity tool enableable software application 211 to execute the best match capability.

At block 530 in an embodiment, it may be determined whether the information handling system has powered down. If the information handling system has powered down, the method for identifying a defined toxic utterance that best matches a received user query input through a text frequency-inverse document frequency (TF-IDF) weighted semantic search that considers context of toxic terms as well as keywords within the user query input may then end. If the information handling system has not powered down, the method may proceed back to block 506 for receipt of a new user query input. By repeating the loop between blocks 506 and 530 in such a way, the hardware processor executing code instructions for the OTB AI productivity tool may identify and provide a defined appropriate response to the determination of any use of toxic utterances within received user query inputs.

The blocks of the flow diagram of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer readable code instructions for a toxic language sensitive on the box (OTB) artificial intelligence (AI) productivity tool comprising:
a hardware processor executing computer-readable program code instructions for generating toxicity intent values from a plurality of natural language descriptions of defined toxic utterances;
a toxic utterance database to store each of the plurality of natural language descriptions of defined toxic utterances with metadata identifying a toxicity type and a defined response to a user query input identified as including one of the defined toxic utterances;
the hardware processor executing computer-readable program code instructions for generating a query input intent value for a user query input received via a user conversational interface software application in text or audio requesting an action to be taken by an AI productivity tool-enableable software application executing on the information handling system;
the hardware processor executing computer-readable program code instructions for performing a toxicity cosine semantic similarity search comparing the query input intent value to the toxicity intent values to identify a matching toxic utterance within natural language of the received user query input having a toxicity intent value that generates a highest toxicity cosine semantic similarity search score; and
the hardware processor executing computer-readable program code instructions for instructing the user conversational interface software application to provide the defined response identified within metadata for the matching toxic utterance.

2. The information handling system of claim 1 further comprising:
the hardware processor executing computer-readable program code instructions of the OTB AI productivity tool for embedding natural language descriptions for the defined toxic utterances and storing the toxicity intent values as vectors in a multi-axis vector space for each of the defined toxic utterances.

3. The information handling system of claim 1 further comprising:
the hardware processor executing computer-readable program code instructions to determine the toxicity intent values generated by execution of code instructions for a text embedding algorithm that mathematically represent semantic meaning for words or phrases within the natural language descriptions for the defined toxic utterances for correlation with the query intent input value generated from the user query input text.

4. The information handling system of claim 1 further comprising:
the hardware processor executing computer-readable program code instructions for weighting the toxicity cosine semantic similarity search score by a term frequency-inverse document frequency (TF-IDF) comparison score for each of the natural language descriptions of the defined toxic utterances by performing a TF-IDF comparison between natural language for the user query input and the natural language descriptions of each of the defined toxic utterances.

5. The information handling system of claim 1, wherein the toxicity cosine semantic similarity search includes determining a degree of angular similarity between vector values for the toxicity intent values and the query input intent value that mathematically represent a correlation between a first phrase within natural language of the user query input and any of a plurality of phrases within the natural language descriptions for the toxic utterances.

6. The information handling system of claim 1 further comprising:
the hardware processor executing computer-readable program code instructions for performing a capabilities cosine semantic similarity search comparing a plurality of capability intent values for natural language descriptions of a plurality of gathered capabilities associated with the AI productivity tool-enablable software application to the query input intent value to identify a best match capability for the received user query input having a capability intent value that generates a highest capabilities cosine similarity search score, when no toxic utterance is detected or wherein the toxicity type is general; and
the hardware processor executing computer-readable program code instructions the AI productivity tool-enableable software application having the best match capability to execute the best match capability in response to the user query input.

7. The information handling system of claim 1, wherein the defined response within the metadata for the matching toxic utterance informs the user that the action cannot be performed when the matching toxic utterance has a heightened toxicity type.

8. A method for executing computer readable code instructions of an on the box (OTB) artificial intelligence (AI) productivity tool at an information handling system to respond to a user query input that includes toxic language comprising:
storing in a toxic utterance database memory each of a plurality of natural language descriptions of defined toxic utterances and toxicity intent values from the plurality of natural language descriptions of the defined toxic utterances with metadata identifying a toxicity type and a defined response to a user query input identified as including one of the defined toxic utterances;
generating, via the hardware processor executing computer-readable program code instructions of a text embedding module of the OTB AI productivity tool, a query input intent value for a user query input received via a user conversational interface software application in text or audio requesting an action to be taken by an AI productivity tool-enableable software application executing on the information handling system;
performing, via the hardware processor executing computer-readable program code instructions, a toxicity cosine semantic similarity search comparing the query input intent value to the toxicity intent values to identify a matching toxic utterance within natural language of the received user query input having a toxicity intent value that generates a highest toxicity cosine semantic similarity search score;
determining, via the hardware processor executing computer-readable program code instructions, that the matching toxic utterance has a heightened toxicity type; and
the hardware processor executing computer-readable program code instructions for instructing the user conversational interface software application to provide the defined response identified within metadata for the matching toxic utterance which includes a denial of performance of the action requested within the user query input.

9. The method of claim 8 further comprising:
executing computer-readable program code instructions, via the hardware processor, of a latent semantic analysis text embedding algorithm for generating the toxicity intent values and the query input intent value.

10. The method of claim 8 further comprising:
executing computer-readable program code instructions, via the hardware processor, of a recurrent neural network (RNN) text embedding algorithm trained to determine importance of order for a first plurality of natural language words within the user query input and other pluralities of natural language words within the natural language descriptions of the defined toxic utterances for generating the toxicity intent values and the query input intent value.

11. The method of claim 8, wherein the defined response notifies the user of inappropriate or toxic language within the received user query input.

12. The method of claim 8, wherein the defined toxic utterances and the defined response for the defined toxic utterances are received at the toxic utterances database memory from an information technology decision maker via a remote server location as a defined toxic utterance policy update.

13. The method of claim 8 further comprising:
executing computer-readable program code instructions, via the hardware processor, for weighting the toxicity cosine semantic similarity search score by a term frequency-inverse document frequency (TF-IDF) comparison score for each of the natural language descriptions of the defined toxic utterances by performing a TF-IDF comparison between natural language for the user query input and the natural language descriptions of each of the defined toxic utterances.

14. The method of claim 8 further comprising:
executing computer-readable program code instructions, via the hardware processor, for performing a capabilities cosine semantic similarity search comparing a plurality of capability intent values for natural language descriptions of a plurality of gathered capabilities associated with the AI productivity tool-enablable software application to the query input intent value to identify a best match capability for the received user query input having a capability intent value that generates a highest capabilities cosine similarity search score, when no toxicity is detected or wherein the toxicity type is general; and
executing computer-readable program code instructions, via the hardware processor, of the AI productivity tool-enableable software application having the best match capability to execute the best match capability in response to the user query input.

15. An information handling system executing computer readable code instructions for a toxic language sensitive on the box (OTB) artificial intelligence (AI) productivity tool comprising:
a toxic utterance database memory to store each of a plurality of natural language descriptions of defined toxic utterances and toxicity intent values generated from the plurality of the natural language descriptions of the defined toxic utterances with metadata identifying a toxicity type and a defined response to a user query input identified as including one of the defined toxic utterances;
the hardware processor executing computer-readable program code instructions for generating a query input intent value for a user query input received via a user conversational interface software application in text or audio requesting an action to be taken by an AI productivity tool-enableable software application executing on the information handling system;
the hardware processor executing computer-readable program code instructions for performing a toxicity term frequency-inverse document frequency (TF-IDF) weighted cosine semantic similarity search comparing the query input intent value to the toxicity intent values to identify a matching toxic utterance within natural language of the received user query input having a general toxicity type and a toxicity intent value that generates a highest toxicity TF-IDF weighted cosine semantic similarity search score;
the hardware processor executing computer-readable program code instructions for instructing the user conversational interface software application to provide the defined response identified within metadata for the matching toxic utterance when the matching toxic utterance is a heightened toxicity type; and
the hardware processor executing computer-readable program code instructions of the OTB AI productivity tool to determine a best match capability responsive to the user query input when the matching toxic utterance is a general toxicity type or no matching toxic utterance is found.

16. The information handling system of claim 15, wherein the defined response notifies the user of inappropriate or toxic language within the received user query input.

17. The information handling system of claim 15 further comprising:
the hardware processor executing computer-readable program code instructions for performing a capabilities cosine semantic similarity search comparing a plurality of capability intent values for natural language descriptions of a plurality of gathered capabilities associated with the AI productivity tool-enablable software application to the query input intent value to identify the best match capability for the received user query input having a capability intent value that generates a highest capabilities TF-IDF weighted cosine similarity search score, when no toxicity is detected or wherein the toxicity type is general; and
the hardware processor executing computer-readable program code instructions the AI productivity tool-enableable software application having the best match capability to execute the best match capability in response to the user query input.

18. The information handling system of claim 15, wherein the defined response within the metadata for the matching toxic utterance informs the user that the action cannot be performed and issues an instruction to the OTB AI productivity tool to not determine or execute the best match capability in response to the user query input when the matching toxic utterance has a heightened toxicity type.

19. The information handling system of claim 15 further comprising:
the hardware processor executing computer-readable program code instructions to determine the toxicity intent values generated by execution of code instructions for a text embedding algorithm that mathematically represent semantic meaning for words or phrases within the natural language descriptions for the defined toxic utterances for correlation with the query intent input value generated from the user query input text. 20 The information handling system of claim 15, wherein the toxicity TF-IDF weighted cosine semantic similarity search includes determining a degree of angular similarity between vector values for the toxicity intent values and the query input intent value that mathematically represent a correlation, as weighted by a TF-IDF comparison, between a first phrase within natural language of the user query input and any of a plurality of phrases within the natural language descriptions for the toxic utterances.
